(19) United States
(12) Patent Application Publication
(10) Pub. No.: US 2023/0020309 A1
(43) Pub. Date: Jan. 19, 2023

(54) LCOS DISPLAY PANEL AND METHOD FOR FABRICATING SAME

(71) Applicant: OMNIVISION SEMICONDUCTOR (SHANGHAI) CO., LTD., Shanghai (CN)

(72) Inventors: Chun-Sheng FAN, Hsinchu City (TW); Regis FAN, Sunnyvale, CA (US)

(21) Appl. No.: 17/474,746

(22) Filed: Sep. 14, 2021

(30) Foreign Application Priority Data
Jul. 14, 2021 (CN) 202110796302.4

(51) Int. Cl. G02F 1/1341; G02F 1/1339; G02F 1/1333

(52) U.S. Cl. CPC G02F 1/1341; G02F 1/1339; G02F 1/133351

(57) ABSTRACT

A liquid crystal on silicon (LCOS) display panel and method for fabricating the LCOS display panel are disclosed. According to the present invention, injection openings for injection a liquid crystal material to cavities (liquid crystal cells) are formed in a glass substrate, and the injection opening extends through the glass substrate, allowing the cavities to have a thickness that is independent of a width of the injection openings and not affected thereby.

### CROSS-REFERENCE TO RELATED APPLICATION

This application claims the priority of Chinese patent application number 202110796302.4, filed on Jul. 14, 2021, the entire contents of which are incorporated herein by reference.

### TECHNICAL FIELD

The present invention pertains to the field of integrated circuit (IC) fabrication technology, and relates in particular to a liquid crystal on silicon (LCOS) display panel and a method for fabricating the LCOS display panel.

### BACKGROUND

Liquid crystal on silicon (LCOS) is a novel LCD display fabricated on monocrystalline silicon, a new technique emerging from the combination of LCD and CMOS IC technologies. LCOS features a high resolution, reflective imaging and low cost.

As shown in FIG. 1, an LCOS display panel includes a silicon substrate 01, a glass substrate 02 and a frame adhesive 03 applied between them along perimeters thereof. In the frame adhesive 03, there is an injection opening 0 through which a liquid crystal material can be introduced. The silicon substrate 01, the glass substrate 02 and the frame adhesive 03 together delimit a cavity (liquid crystal cell) having a cell thickness h measured as a thickness of the cavity (in the direction perpendicular to the silicon substrate 01). The cell thickness h is equal to a width of the injection opening 0. Common ways for introducing the liquid crystal material include vacuum filling and one drop filling (ODF).

As shown in FIG. 2, in the vacuum filling method, the LCOS display panel is rotated 90 degrees and the injection opening 0 is immersed in the liquid crystal material 04 in a container so that the liquid crystal material 04 is drawn into the cavity by capillary action. When the cell thickness h of the LCOS display panel is relatively large (large cell), there is a significantly increased risk for contaminants D (foreign matters) to be also filled in the cavity together with the liquid crystal material, which may adversely affect the quality and yield of the LCOS display panel. Moreover, in order to get rid of moisture that is detrimental to the service life of the final product, the cavity is prohibited from water cleaning before the liquid crystal material is injected, making removal of contaminants more difficult.

Some applications require injecting an LCOS display panel with a high viscous liquid crystal material. The high viscous liquid crystal material affects the capillary action. For the high viscous liquid crystal material, in order to create sufficient capillary action during vacuum filling, a wider injection opening 0 is necessary, which, however, as discussed above, tends to be associated with a higher risk of introducing contaminants D into a cavity (liquid crystal cell) of the LCOS display panel.

ODF filling requires the use of expensive equipment including a high-precision nozzle that does not support the filling of viscous liquid crystal materials.

### SUMMARY OF THE INVENTION

The present invention provides a liquid crystal on silicon (LCOS) display panel and a method for fabricating the LCOS display panel.

It is an object of the present invention to lower the possibility of entry of dust and other contaminants into a cavity (liquid crystal cell) during a filling process and thus minimize the presence of contaminants in the cavity.

It is another object of the present invention to support the filling of high viscous liquid crystal materials.

It is yet another object of the present invention to dispense with the need to flip or rotate the LCOS display panel and thus reduce the risk of misoperation of production line equipment or operators.

The present invention provides an LCOS display panel comprising:

a semiconductor substrate, a glass substrate, a frame adhesive and a liquid crystal layer,

wherein: the frame adhesive is disposed between the semiconductor substrate and the glass substrate in a shape of rings so that the semiconductor substrate, the frame adhesive and the glass substrate delimit a cavity,

wherein the glass substrate is provided with an injection opening and wherein the injection opening extends through the glass substrate, and,

wherein the liquid crystal layer is formed by filling the cavity with a liquid crystal material through the injection openings.

Additionally, the glass substrate may be provided with a protective film on a side surface of the glass substrate away from the semiconductor substrate, the protective film covering the injection opening.

Additionally, the LCOS display panel may comprise a plurality of of LCOS dies, wherein each of the plurality of LCOS dies is rectangular.

Additionally, each of the plurality of LCOS dies may have one or two injection openings, wherein in a cross-sectional plane along the semiconductor substrate, the frame adhesive delimits a rectangular area or a substantially rectangular area, and in an event of the LCOS die having one injection opening, the one injection opening is positioned at a corner of the rectangular or substantially rectangular area delimited by the frame adhesive, or in an event of the specific LCOS die having two injection openings, the two injection openings are positioned at diagonal corners of the rectangular or substantially rectangular area delimited by the frame adhesive.

Additionally, directions in which mutually perpendicular sides of the rectangular die extend are defined respectively as a first direction and a second direction, wherein along the second direction, solder pads may be provided in a peripheral region of the semiconductor substrate, and wherein the solder pads are exposed each of both the glass substrate and the frame adhesive.

Additionally, in a cross-sectional plane along dice line extending in the second direction, side surfaces of the glass substrate, the frame adhesive and the semiconductor substrate of each of the plurality of LCOS dies may be flush with each other.

Additionally, the LCOS display panel may further comprise a sealing adhesive, wherein the sealing adhesive fills the injection opening and thus encloses the liquid crystal layer within the cavity.

Additionally, the semiconductor substrate may be provided with a pixel structure therein, and a first polyimide layer is provided on a side of the semiconductor substrate facing the glass substrate, wherein an indium tin oxide (ITO) layer and a second polyimide layer are sequentially formed on a side surface of facing the semiconductor substrate, the injection openings extend through each of the ITO layer and the second polyimide layer.

The present invention also provides a method for fabricating an LCOS display panel, the method comprising:

providing a semiconductor substrate and a glass substrate, wherein the glass substrate is provided with an injection opening, and wherein the injection opening extends through the glass substrate;

adhesively bonding the semiconductor substrate and the glass substrate by using a frame adhesive, wherein the frame adhesive is disposed between the semiconductor substrate and the glass substrate in a shape of rings so that the semiconductor substrate, the frame adhesive and the glass substrate delimit a cavity; and

forming a liquid crystal layer in the cavity by filling the cavities with a liquid crystal material through the injection opening.

Additionally, the liquid crystal layer may be formed by filling the liquid crystal material through the injection opening by a liquid crystal injection.

Additionally, the providing the glass substrate may further comprise: providing a protective film on a side surface of the glass substrate away from the semiconductor substrate, and

removing the protective film subsequent to bonding the semiconductor substrate and the glass substrate and prior to the formation of the liquid crystal layer.

Additionally, the method may further comprise, subsequent to forming the liquid crystal layer, forming a sealing adhesive, wherein the sealing adhesive fills the injection openings to enclose the liquid crystal layer in the cavity.

Additionally, the method may further comprise, subsequent to forming the sealing adhesive, dicing the LCOS display panel into a plurality of LCOS dies.

Compared with the prior art, the present invention has the following advantages.

It provides an LCOS display panel and a method for fabricating the same. According to the present invention, injection openings for injection a liquid crystal material to cavities (liquid crystal cells) are formed in a glass substrate, and the injection opening extend through the glass substrate. This design with the injection openings arranged above the cavities (liquid crystal cells) allows the cavities to have a thickness that is independent of a width of the injection openings and not affected thereby. As a result, even when the cell thickness of the LCOS display panel is relatively large (large cells), the width of the injection openings can be determined as desired, thus overcoming the prior-art problem that a greater cell thickness is associated with higher risk of egress of contaminants to cavities and allowing higher yield of the LCOS display panel. With the present invention, the possibility of entry of dust and other contaminants into the cavities (liquid crystal cells) during a filling process is lowered, resulting in minimized presence of contaminants within the cavities. In addition, filling of high viscous liquid crystal materials is supported, entailing a novel approach that addresses the challenge of filling high viscous liquid crystal materials to the conventional ODF method. Further, flipping or rotating of the LCOS display panel is not involved at all, resulting in reduced risk of misoperation of production line equipment or operators.

### BRIEF DESCRIPTION OF THE DRAWINGS

FIG. 1 is a schematic illustration of a liquid crystal on silicon (LCOS) display panel.

FIG. 2 schematically illustrates vacuum injection of the LCOS display panel of FIG. 1 with a liquid crystal material.

FIG. 3 schematically illustrates a semiconductor substrate and a glass substrate in an LCOS display panel according to an embodiment of the present invention.

FIG. 4 schematically illustrates the LCOS display panel after a frame adhesive is provided according to an embodiment of the present invention.

FIG. 5 schematically illustrates the LCOS display panel after a protective film is removed according to an embodiment of the present invention.

FIG. 6 schematically illustrates the LCOS display panel after liquid crystal layers are formed according to an embodiment of the present invention.

FIG. 7 schematically illustrates the LCOS display panel after a sealing adhesive is filled according to an embodiment of the present invention.

FIG. 8a schematically illustrates a comparison drawn between the LCOS display panel of the present invention and a conventional LCOS display panel.

FIG. 8b is a schematic top view of the LCOS display panel of the present invention of FIG. 8a.

FIG. 9 schematically illustrates a scenario with each die of the LCOS display panel having two injection openings according to an embodiment of the present invention.

FIG. 10 schematically illustrates a scenario with each die of the LCOS display panel having one injection opening according to an embodiment of the present invention.

FIG. 11 is a flowchart of a method for fabricating an LCOS display panel according to an embodiment of the present invention.

In these figures,

01: a silicon substrate; 02: a glass substrate; 03: a frame adhesive; 04: a liquid crystal material; 0: an injection opening; D: a contaminant; 11: a semiconductor substrate; 12: a first PI layer; 13: a pixel structure; 21: a glass substrate; 22: a second PI layer; 23: a protective film; V: an injection opening; P: a cavity; 31: a frame adhesive; 32: a liquid crystal layer; 33: a sealing adhesive; and 34: a solder pad.

### DETAILED DESCRIPTION

In view of the above, in embodiments of the present invention there is provided a liquid crystal on silicon (LCOS) display panel and a method for fabricating the LCOS display panel. The present invention will be described in greater detail below by way of specific embodiments with reference to the accompanying drawings. From the following description, advantages and features of the present invention will become more apparent. Note that the figures are provided in a very simplified form not necessarily drawn to scale for the only purpose of helping to explain the disclosed embodiments in a more convenient and clearer way.

In embodiments of the present invention, there is provided an LCOS display panel comprising:

a semiconductor substrate, a glass substrate, a frame adhesive and liquid crystal layers,

the frame adhesive disposed between the semiconductor substrate and the glass substrate in the shape of rings so that the semiconductor substrate, the frame adhesive and the glass substrate together delimit cavities,

the glass substrate is provided with injection openings extending through the glass substrate,

the liquid crystal layers formed by filling the cavities with a liquid crystal material through the injection openings.

The semiconductor substrate 11 may be provided on a side thereof facing the glass substrate 21 with a first polyimide (PI) layer 12 covering the pixel structure 13. The first PI layer 12 may serve as an orientation layer for orienting the liquid crystal layers. In other embodiment, the first polyimide (PI) layer 12 and/or a silicon oxide layer may be provided on the side of the semiconductor substrate 11 facing the glass substrate 21.

The injection openings V are formed in the glass substrate, and the injection openings V extends through the glass substrate. An indium tin oxide (ITO) layer (not shown) may be provided on a side of the glass substrate 21 facing the semiconductor substrate 11, and a second polyimide (PI) layer 22 may be in turn provided on the ITO layer. The injection openings V may further extend through both the ITO layer and the second PI layer 22. The indium tin oxide (ITO) layer may serve as a transparent electrode. The glass substrate 21 may be provided on a side thereof away from the semiconductor substrate 11 with a protective film 23 which covers the injection openings V to prevent the egress of contaminants such as dust through the injection openings V. On the side of the glass substrate 21 away from the semiconductor substrate 11, an anti-reflection (AR) layer may be also provided between the glass substrate 21 and the protective film 23. After the glass substrate 21 is aligned with and adhered to the semiconductor substrate 11, a liquid crystal material may be injected through the injection openings (provided individually or in pairs).

As shown in FIG. 4, in the LCOS display panel, the frame adhesive 31 is disposed between the semiconductor substrate 11 and the glass substrate 21 in the shape of rings so that the semiconductor substrate 11, the frame adhesive 31 and the glass substrate 21 together delimit cavities P.

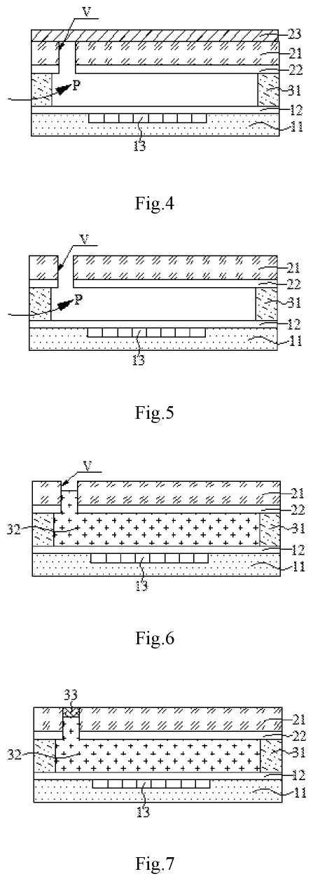

As shown in FIG. 5, the protective film 23 may be removed before the formation of the liquid crystal layers.

As shown in FIG. 6, the liquid crystal layers 32 are formed from a liquid crystal material filled in the cavities P through the injection openings V. Specifically, the second PI layer 22 faces the first PI layer 12 and the liquid crystal layers 32 may be formed between the second PI layer 22 and the first PI layer 12. The second PI layer 22 is disposed over the liquid crystal layers 32. The first PI layer 12 and the second PI layer 22 can orient liquid crystal molecules in the liquid crystal layer 32 near those PI layers 12, 22 respectively. The frame adhesive 31 seals the liquid crystal layers 32 between the first PI layer 12 and the second PI layer 22. The frame adhesive 31 is disposed so as to frame and delimit the liquid crystal layers 32. The frame adhesive 31 disposed between the first PI layer 12 and the second PI layer 22 holds the semiconductor substrate 11 and the glass substrate 21 together. The frame adhesive 31 may be formed of a UV curable material, or a material curable over time or at a certain temperature, or a photo-patternable material.

As shown in FIG. 7, the LCOS display panel may further include a sealing adhesive 33, which is filled in the injection openings so as to enclose the liquid crystal layers in the cavities.

After the sealing adhesive 33 is applied to seal the injection openings, the LCOS display panel may be diced into a number of LCOS dies each has one or more of the injection openings.

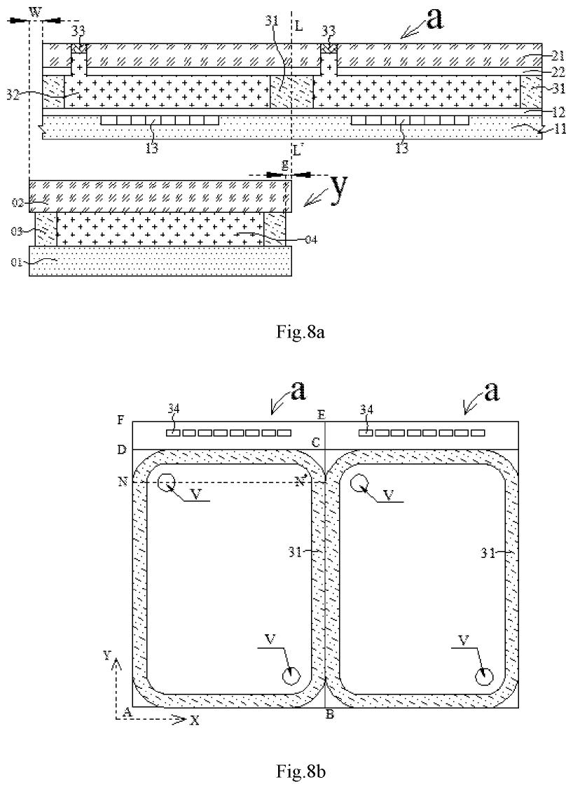

FIG. 8a schematically illustrates a comparison drawn between the LCOS display panel according to this embodiment (containing LCOS dies a) and a conventional LCOS display panel (containing an LCOS die y). FIG. 8b is a schematic top view of the LCOS display panel of FIG. 8a. In FIG. 8a, a cross section of the LCOS display panel along NN′ in FIG. 8b is shown.

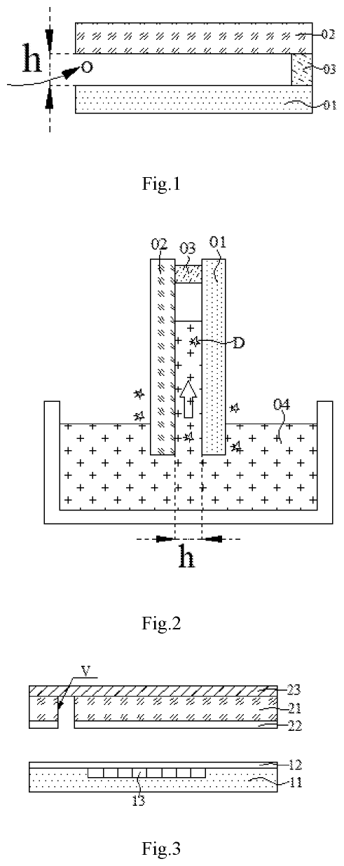

The conventional LCOS display panel (containing the LCOS die y) shown in FIG. 8a may be taken as a continuation of the example of FIGS. 1 and 2 with the vacuum filling having been completed and the injection opening 0 having been closed. During fabrication of the conventional LCOS display panel, the silicon substrate 01 and the glass substrate 02 as shown are usually obtained from a dicing process, which is followed by applying the frame adhesive 03 to the silicon substrate 01 and bonding the glass substrate 02 to the silicon substrate 01 via the frame adhesive 03. In order to prevent the frame adhesive 03 in each LCOS die y from spreading beyond a peripheral edge of the silicon substrate 01, the frame adhesive 03 is usually so applied that there is a marginal gap of g left between its outer edge and that of the silicon substrate 01 on each side. Therefore, for each LCOS die y, marginal gaps g on both sides are necessary, leading to the waste of a width of 2*g.

As shown in FIGS. 8a and 8b, according to this embodiment, each LCOS die a may have a rectangular (including square) shape, with the directions in which their mutually perpendicular sides extend being defined respectively as a first (e.g., X-axis) direction and a second (e.g., Y-axis) direction. For example, along the second (e.g., Y-axis) direction, solder pads 34 may be provided in a peripheral region of the semiconductor substrate 11 and the solder pads 34 are exposed from each of the glass substrate 21 and the frame adhesive 31. Specifically, in a top view of each LCOS die a, the glass substrate 21 (as indicated by area ABCD, for example) may encompass a ring of the frame adhesive 31, with a portion (e.g., CDFE) of the semiconductor substrate 11 (e.g., ABEF) being exposed from both the glass substrate 21 and the frame adhesive 31, and the solder pad 34 may be arranged in this exposed portion (e.g., CDFE) as signal input/output (I/O) ports. The solder pads 34 be bonded by metal wires and arranged side by side along the first (e.g., X-axis) direction.

In addition, in cross-sectional planes of each LCOS die along dice lines extending in the second (e.g., Y-axis) direction, side surfaces of the glass substrate, the frame adhesive and the semiconductor substrate may be flush with one another. Specifically, in the top view, ABEF are dicing lines corresponding to the single LCOS die a, the cross-sectional planes along the dice lines may be perpendicular to the plane of the semiconductor substrate 11. More specifically, right-hand side surfaces of the glass substrate 21, the frame adhesive 31 and the semiconductor substrate 11 in the cross-sectional plane along the dice line BE may be flush (co-planer) with one another, and left-hand side surfaces of the glass substrate 21, the frame adhesive 31 and the semiconductor substrate 11 in the cross-sectional plane along the dice line AF may be also flush (co-planer) with one another. However, rear side surfaces of the glass substrate 21, the frame adhesive 31 and the semiconductor substrate 11 in the cross-sectional plane designated EF are not flush with one another.

According to this embodiment, the glass substrate 21 and the semiconductor substrate 11 (parental substrates) are bonded with the frame adhesive 31, followed by dicing the resulting bonded structure into a number of LCOS dies a. As shown in FIG. 8a, for the two adjacent LCOS dies a bordered by line LL′, the frame adhesive 31 may be applied along the border as a single part for both the dies, without needing to keep a marginal gap of g. Similarly, according to this embodiment, for any two LCOS dies a that are adjacent to each other along a one-dimensional direction (e.g., the X-direction), the frame adhesive 31 may be applied along their border as a single part for both the dies, without needing to keep a marginal gap of g. In this way, according to this embodiment, for each LCOS die a, the need of keeping a marginal gap of g on each lateral side (e.g. along the X-direction) is dispensed with, result in a saving in width of W (W=2*g).

According to this embodiment, after the LCOS display panel is diced into individual LCOS dies, for each of these dies, in cross-sectional planes along dice lines on sides not with solder pads or for signal I/O (e.g., AF and BE, as shown), side surfaces of the glass substrate 21, the frame adhesive 31 and the semiconductor substrate 11 may be flush (co-planer) with one another, in order to result in savings in width in one or more one-dimensional directions (e.g., the X-direction) by dispensing the need of keeping marginal gaps of g external to the frame adhesive (e.g., in the X-direction). This allows increased miniaturization of the individual LCOS dies.

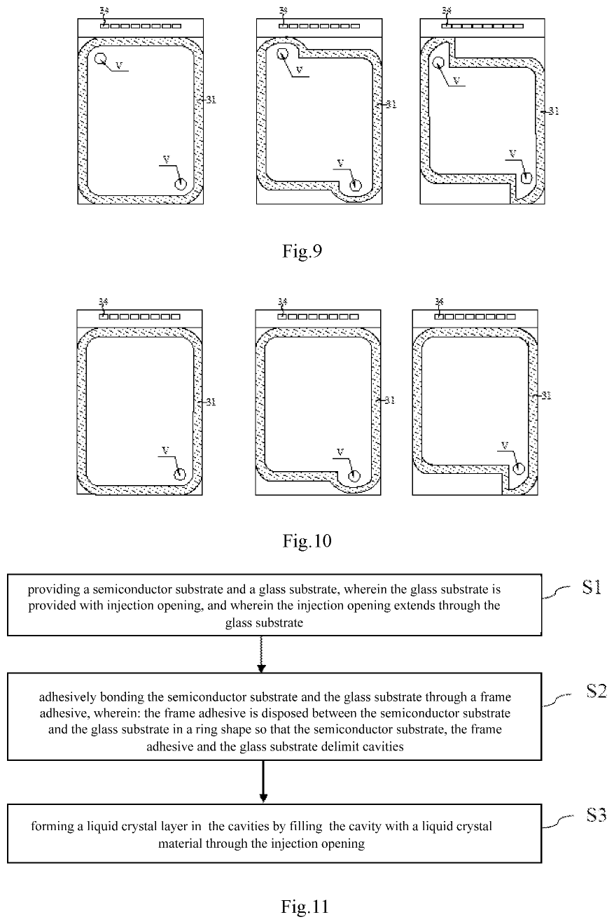

As shown in FIGS. 9 and 10, each LCOS die may have one or two injection openings V. In a cross-sectional plane parallel to the semiconductor substrate, the frame adhesive 31 may delimit a rectangular or substantially rectangular area. FIG. 9 shows a scenario with two injection openings V being positioned at diagonal corners of the rectangular or substantially rectangular area delimited by the frame adhesive 31. FIG. 10 shows a scenario with one injection opening V being positioned at a corner of the rectangular or substantially rectangular area delimited by the frame adhesive 31. In the scenarios shown in FIGS. 9 and 10, while not wishing to be so limited, the corners of the area defined by the frame adhesive 31 may be curved as practically required.

In embodiments of the present invention, there is also provided a method for fabricating an LCOS display panel, which, as shown in FIG. 11, includes the steps of:

S1: providing a semiconductor substrate and a glass substrate, the glass substrate is provided with injection openings extending therethrough;

S2: adhesively bonding the semiconductor substrate and the glass substrate by using a frame adhesive, wherein the frame adhesive is disposed between the semiconductor substrate and the glass substrate in the shape of rings so that the semiconductor substrate, the frame adhesive and the glass substrate together delimit cavities; and

S3: forming liquid crystal layer in the cavities by filling the cavities with a liquid crystal material through the injection openings.

The steps in the method will be described in detail below with reference to FIGS. 3 to 7.

As shown in FIG. 3, providing the semiconductor substrate 11, wherein a pixel structure 13 and associated circuit are formed in the semiconductor substrate 11. A first polyimide (PI) layer 12 may be formed on a side of the semiconductor substrate 11 facing the glass substrate 21.

Providing the glass substrate 21, wherein an indium tin oxide (ITO) layer (not shown) and a second PI layer 22 may be sequentially formed on a side of the glass substrate 21 facing the semiconductor substrate 11. The ITO layer may be formed by sputtering or coating. The injection openings V formed in the glass substrate 21 may extend through all the glass substrate 21, the ITO layer and the second PI layer 22.

On a side of the glass substrate 21 away from the semiconductor substrate 11, a protective film 23 may be provided so as to cover the injection openings V to prevent the egress of contaminants such as dust through the injection openings V.

Specifically, the formation of the first and second PI layers 12, 22 as liquid crystal orienting layers may involve the application of a PI solution and a rubbing process.

Specifically, after the PI solution is dispensed on surfaces of the semiconductor substrate 11 and the ITO layer on the glass substrate 21, the substrates may undergo a spin coating process carried out on a spin coater at a predetermined rotational speed for a period of time (e.g., 60-100 s) to uniformly coat the PI solution. The two substrates (i.e., the semiconductor substrate 11 and the glass substrate 21) coated with the PI solution may be preheated on a heating platform and then heated at a preset curing temperature (e.g., 200-250° C.). After that, the substrates may be taken away after the temperature drops to room temperature.

The semiconductor substrate 11 may be then fixed at a designated location on a setup for rubbing, then adjusting a distance between a rubbing roller and the substrate to be rubbed, followed by adjusting the rotation speed (e.g., 2000-2500 rpm) of the rubbing roller, finally the PI layer on the substrate is rapidly rubbed against the rubbing roller in order to compete the orientation thereof. The PI layer on the glass substrate 21 may be then processed in a similar manner. In this way, the first and second PI layers 12, 22 can be obtained.

As shown in FIG. 4, the semiconductor substrate 11 and the glass substrate 21 are adhesively bonded through the frame adhesive 31 in such a manner that the frame adhesive 31 is disposed between the semiconductor substrate 11 and the glass substrate 21 in the shape of rings so that the semiconductor substrate 11, the frame adhesive 31 and the glass substrate 21 together delimit cavities P. Specifically, the frame adhesive 31 may be uniformly applied to surface areas of the semiconductor substrate 11, which surround those reserved for the liquid crystal layers and do not encompass the injection openings V, in order to ensure that the injection openings V are in communication with the subsequently formed cavities P. The glass substrate 21 may be lowered with the side coated with the second PI layer 22 and pressed onto the side of the semiconductor substrate 11 coated with the frame adhesive 31. After the frame adhesive 31 is cured, the cavities P (liquid crystal cells) are formed. As an example, the frame adhesive 31 can be cured by exposing it to UV radiation for 3-5 minutes and then heating it at 100-115° C. in an infrared oven for 25-35 minutes. During the formation of the cavities P (liquid crystal cells), alignment between the semiconductor substrate 11 and the glass substrate 21 may be accomplished using alignment marks with accuracy of less than ±2 microns.

As shown in FIG. 5, the protective film 23 may be removed prior to the formation of the liquid crystal layers.

As shown in FIG. 6, the liquid crystal layers 32 may be formed by injecting a liquid crystal material into the cavities via the injection openings V by liquid crystal injection (LC injection) method. Specifically, the liquid crystal material in a solid state may be heated and melted and then injected with a fluid syringe by using a LC injection machine. A resistive heating wire may be wound over the fluid syringe in order to ensure that the liquid crystal material is injected from the syringe at a temperature, which is controlled within a range between the melting point and the solidification point of the liquid crystal material to allow easy flow of the material within the syringe. The liquid crystal material may be chosen as one with a high refractive index.

As shown in FIG. 7, forming a sealing adhesive 33, wherein the sealing adhesive 33 may be filled in the injection openings to enclose the liquid crystal layer 32 in the cavities. This may be done from a top side of the glass substrate 21 subsequent to the filling of the liquid crystal material, entailing a design and process capable of keeping the cavities ultra-clean.

After that, the method may further include dicing the LCOS display panel into a number of individual LCOS dies.

According to this embodiment, the glass substrate 21 and the semiconductor substrate 11 are first bonded together with the frame adhesive 31 and the resulting LCOS display panel is diced into a number of individual LCOS dies. In this way, for any adjacent LCOS dies, the frame adhesive may be applied along their border as a single part for both the dies without needing to keep marginal gaps. Specifically, according to this embodiment, a marginal gap of g can be saved on both sides of each LCOS die, resulting in a total saving in width of W. As a result, the individual LCOS dies can be fabricated with reduced size, and more LCOS dies can be fabricated from a single LCOS display panel, resulting in reduced cost per LCOS die.

According to embodiments of the present invention, the LCOS display panels may be used in the manufacturing of various high-definition and high-brightness projectors, 3D glasses and head-mounted displays. Moreover, they can also be integrated in mobile phones, computers, satellite receivers, wired and network set-top boxes, video cameras, DVD players and many other electronic imaging devices. Therefore, they are of great practical utility.

In summary, the present invention provides an LCOS display panel and a method for fabricating the same. According to the present invention, injection openings for introducing a liquid crystal material to cavities (liquid crystal cells) are formed in a glass substrate, and the injection openings extend through the glass substrate. In this way, the cavities (liquid crystal cells) may have a thickness (a distance of the glass substrate from a semiconductor substrate in a direction perpendicular to the semiconductor substrate) that is independent of a width of the injection openings and not affected thereby. As a result, even when the cell thickness h of the LCOS display panel is relatively large (large cells), the width of the injection openings can be still determined as desired, thus overcoming the prior-art problem that a greater cell thickness h is associated with higher risk of egress of contaminants D to cavities (liquid crystal cells) and allowing higher yield of the LCOS display panel. This lowers the possibility of entry of dust and other contaminants into the cavities (liquid crystal cells), resulting in minimized presence of contaminants within the cavities (liquid crystal cells). In addition, filling of the liquid crystal material is allowed to be accomplished by injection, making it also applicable to high viscous liquid crystal materials. Thus, the present invention entails a novel approach that addresses the challenge of filling high viscous liquid crystal materials to the conventional ODF method. Further, flipping or rotating of the LCOS display panel is not involved at all, resulting in reduced risk of misoperation of production line equipment or operators.

The embodiments disclosed herein are described in a progressive manner, with the description of each embodiment focusing on its differences from others. Reference can be made between the embodiments for their identical or similar parts. Since the method embodiments correspond to the LCOS die embodiments, they are described relatively briefly, and reference can be made to the LCOS die embodiments for details in them.

While the invention has been described above with reference to several preferred embodiments, it is not intended to be limited to these embodiments in any way. In light of the teachings hereinabove, any person of skill in the art may make various possible variations and changes to the disclosed embodiments without departing from the scope of the invention. Accordingly, any and all such simple variations, equivalent alternatives and modifications made to the foregoing embodiments without departing from the scope of the invention are intended to fall within the scope thereof.

What is claimed is:

1. A liquid crystal on silicon (LCOS) display panel, comprising:
a semiconductor substrate, a glass substrate, a frame adhesive and a liquid crystal layer,
wherein the frame adhesive is disposed between the semiconductor substrate and the glass substrate in a ring shape, so that the semiconductor substrate, the frame adhesive and the glass substrate delimit a cavity,
wherein the glass substrate is provided with an injection opening, and wherein the injection opening extends through the glass substrate, and
wherein the liquid crystal layer is formed by filling the cavity with a liquid crystal material through the injection opening.

2. The LCOS display panel of claim 1, wherein the glass substrate is provided with a protective film on a side surface of the glass substrate away from the semiconductor substrate, the protective film covering the injection opening.

3. The LCOS display panel of claim 1, comprising a plurality of LCOS dies, wherein each of the plurality of LCOS dies is rectangular.

4. The LCOS display panel of claim 3, wherein each of the plurality of LCOS dies has one or two injection openings, and
wherein in a cross-sectional plane along the semiconductor substrate, the frame adhesive delimits a rectangular area or a substantially rectangular area, and in an event of the LCOS die having one injection opening, the one injection opening is positioned at a corner of the rectangular or substantially rectangular area delimited by the frame adhesive, or in an event of the LCOS die having two injection openings, the two injection openings are positioned at diagonal corners of the rectangular or substantially rectangular area delimited by the frame adhesive.

5. The LCOS display panel of claim 3, wherein directions in which mutually perpendicular sides of the rectangular die extend are defined respectively as a first direction and a second direction, wherein along the second direction, solder pads are provided in a peripheral region of the semiconductor substrate, and wherein the solder pads are exposed from each of the glass substrate and the frame adhesive.

6. The LCOS display panel of claim 5, wherein in a cross-sectional plane along a dice line extending in the second direction, side surfaces of the glass substrate, the frame adhesive and the semiconductor substrate of each of the plurality of LCOS dies are flush with each other.

7. The LCOS display panel of claim 1, further comprising a sealing adhesive, wherein the sealing adhesive fills the injection opening and thus encloses the liquid crystal layer within the cavity.

8. The LCOS display panel of claim 1, wherein:
the semiconductor substrate is provided with a pixel structure therein, and a first polyimide layer is provided on a side surface of the semiconductor substrate facing the glass substrate; and
an indium tin oxide (ITO) layer and a second polyimide layer are sequentially formed on a side surface of the glass substrate facing the semiconductor substrate, the injection opening extending through each of the ITO layer and the second polyimide layer.

9. A method for fabricating a liquid crystal on silicon (LCOS) display panel, wherein the method comprises:
providing a semiconductor substrate and a glass substrate, wherein the glass substrate is provided with an injection opening, and wherein the injection opening extends through the glass substrate;
adhesively bonding the semiconductor substrate and the glass substrate by using a frame adhesive, wherein: the frame adhesive is disposed between the semiconductor substrate and the glass substrate in a ring shape, so that the semiconductor substrate, the frame adhesive and the glass substrate delimit a cavity; and
forming a liquid crystal layer in the cavity by filling the cavity with a liquid crystal material through the injection opening.

10. The method of claim 9, wherein the liquid crystal layer is formed by filling the liquid crystal material through the injection opening by a liquid crystal injection.

11. The method of claim 9, wherein the providing the glass substrate further comprises:
providing a protective film on a side surface of the glass substrate away from the semiconductor substrate; and
removing the protective film subsequent to bonding the semiconductor substrate and the glass substrate and prior to forming the liquid crystal layer.

12. The method of claim 9, further comprising, subsequent to forming the liquid crystal layer, forming a sealing adhesive, wherein the sealing adhesive fills the injection opening to enclose the liquid crystal layer in the cavity.

13. The method of claim 12, further comprising, subsequent to forming the sealing adhesive, dicing the LCOS display panel into a plurality of LCOS dies.
